(19) United States
(12) Patent Application Publication
(10) Pub. No.: US 2013/0047331 A1
(43) Pub. Date: Feb. 28, 2013

(54) QUICK LOCK TENSION ROD AND ASSOCIATED METHODS

(71) Applicants: Maurice Stafford Parker, Kinston, NC (US); Willie Strong, Goldsboro, NC (US); Melvin Walker, JR., Goldsboro, NC (US); Stephen Blair Brooks, Clemmons, NC (US)

(72) Inventors: Maurice Stafford Parker, Kinston, NC (US); Willie Strong, Goldsboro, NC (US); Melvin Walker, JR., Goldsboro, NC (US); Stephen Blair Brooks, Clemmons, NC (US)

(73) Assignee: GLENOIT LLC, Goldsboro, NC (US)

(21) Appl. No.: 13/222,916

(22) Filed: Aug. 31, 2011

(51) Int. Cl. A47K 3/38; B23P 11/00

(52) U.S. Cl. 4/610; 29/428

(57) ABSTRACT

Methods and apparatuses are described for providing a telescoping, load-supporting rod assembly. In one embodiment, the rod assembly may include a first portion, a second portion, a locking assembly, and a tension adjustment assembly. The locking assembly may include a threaded bolt, a cylindrical sleeve, a cylindrical locking portion, and at least two securing pins. The locking assembly may allow a user to adjust an overall length of the rod assembly by allowing the first and second portions to move with respect to each other. The rod assembly may also include a tension adjustment assembly which may include a tension adjusting spring, a tension adjusting cylindrical tube, a spring clip, at least two rivets, and at least two spacers. The tension adjustment assembly may allow a user to make small changes to the length of the rod assembly at one of the ends without moving the first or second portions with respect to each other. Corresponding and additional embodiments of rod assemblies and related methods of the present invention are also provided.

### TECHNOLOGICAL FIELD

The present invention relates to curtain rods, and in particular, shower curtain rods configured to be adjustable in length and to be easily locked into position.

### BACKGROUND

Shower curtain rods are configured to hold a shower curtain and/or shower curtain liner within a shower stall or bathtub to minimize water egress from the shower or bath when a shower head is used. However, shower stalls, bathtubs and other enclosures can vary in size. As such, adjustable shower curtain rods are desirable for accommodating the differently sized shower stalls, bathtubs, and similar spaces. Further, shower curtain rods have been used to function as a towel or clothing rack such as for drying towels, clothes, or other articles. Accordingly, shower curtain rods, while adjustable, should also provide enough support for additional uses, such as functioning as a towel or clothing rack. Therefore, it would be beneficial to provide a shower curtain rod that is easily adjustable, sturdy, and securable in a final desired position.

### BRIEF SUMMARY

One or more embodiments of a rod assembly and associated methods are disclosed herein that address one or more of the above issues. According to embodiments of the present invention, a telescoping, load-supporting rod assembly may be configured to be extended to engage opposing surfaces, the rod assembly comprising a first portion extending between a first end and a second end, wherein the first portion defines an outer diameter. Further, the rod assembly may include a second portion extending between a first end and a second end, wherein the second portion defines a cavity extending from the first end of the second portion and the cavity has an inner diameter that is larger than the outer diameter defined by the first portion, such that the second portion is configured to receive at least a part of the first portion within the cavity via the first end of the second portion. In addition, the rod assembly may include a tension adjustment assembly attached to the first portion proximate the first end of the first portion, wherein the tension adjustment assembly is configured to increase the length of the rod assembly while maintaining the relative position of the first and second portions with respect to each other, such that an engagement of the first and second portions with the opposing surfaces is enhanced. According to one embodiment, the rod assembly may further comprise a locking assembly attached to the second end of the first portion, wherein the locking assembly is configured to secure the first and second portions with respect to each other.

According to one embodiment, a rod assembly may comprise a locking assembly, wherein the locking assembly may include a threaded bolt defining a head portion and an elongated portion, wherein the elongated portion comprises a threaded portion. In another embodiment, the locking assembly may comprise a cylindrical locking portion defining a first longitudinal channel configured to receive the elongated portion of the threaded bolt. Further, the locking assembly may include a cylindrical sleeve defining a second longitudinal channel that is aligned with the first longitudinal channel, wherein the second longitudinal channel comprises internal threads configured to engage the threaded portion of the elongated portion of the threaded bolt, wherein the cylindrical locking portion is configured to be disposed between the head portion of the threaded bolt and the cylindrical sleeve, and wherein the cylindrical sleeve is configured to engage the first portion of the rod assembly and the cylindrical locking portion is configured to selectively engage the second portion of the rod assembly, wherein as the head portion of the threaded bolt is advanced toward the cylindrical sleeve as a result of the engagement of the threaded portion with the cylindrical sleeve, contact between the head portion and the cylindrical locking portion and between the cylindrical sleeve and the cylindrical locking portion causes a diameter of the cylindrical locking portion to expand so as to secure the first and second portions with respect to each other.

In another embodiment, a head portion of the threaded bolt may define a plurality of apertures configured to receive securing pins therethrough for securing the threaded bolt to the cylindrical locking portion. Further, the rod assembly may be configured such that when the threaded portion of the threaded bolt is received within the second longitudinal channel of the cylindrical sleeve, rotation of the first portion in a clockwise direction relative to the second portion advances the head portion of the threaded bolt toward the cylindrical sleeve. Additionally, the rod assembly may be configured such that when the threaded portion of the threaded bolt is received within the second longitudinal channel of the cylindrical sleeve, rotation of the first portion in a counterclockwise direction relative to the second portion causes the cylindrical sleeve to disengage from with the threaded portion such that the head portion of the threaded bolt is moved away from the cylindrical sleeve.

In another embodiment, the rod assembly may further comprise a foot member coupled proximate the first end of the first portion, wherein the foot member is configured to engage a corresponding opposing surface. According to one embodiment, the tension adjustment assembly may comprise a tension adjusting cylindrical tube disposed at least partially within a cavity of the first portion and attached to the foot member of the first portion such that movement of the tension adjusting cylindrical tube results in movement of the attached foot member, relative to the first portion, between a first position and a second position, wherein in the second position the length of the rod assembly is increased such that an engagement of the first and second portions with the opposing surfaces is enhanced. According to another embodiment, the tension adjustment assembly may include a tension adjusting spring disposed within the cavity of the first portion and having a fixed end that is fixed with respect to the first portion and a movable end that is movable with respect to the first portion, wherein the movable end is coupled to the tension adjusting cylindrical tube such that the tension adjusting cylindrical tube is biased toward the second position.

In another embodiment, the tension adjustment assembly may comprise a first guide member coupled to the fixed end of the spring and configured to engage at least one aperture defined by the first portion so as to couple the tension adjustment assembly to the first portion at the fixed end of the spring. According to one embodiment, the tension adjusting cylindrical tube may define an aperture, wherein the tension adjustment assembly further comprises a spring clip disposed at least partially within and attached to the tension adjusting cylindrical tube, wherein the spring clip includes an extension tab configured to extend through the aperture, wherein the extension tab is configured to pass through a corresponding opening of the first portion when the tension adjustment assembly is disengaged so as to prevent movement of the tension adjusting cylindrical tube toward the second position, and wherein the extension tab is configured to be depressed so as to define an engaged position of the tension adjustment assembly, in which the extension tab is received within the first portion so as to allow movement of the tension adjusting cylindrical tube toward the second position as a result of a spring force of the tension adjusting spring.

In one embodiment, the rod assembly may comprise a tension adjusting cylindrical tube that defines at least one slot and wherein the tension adjustment assembly further comprises a second guide member, wherein at least one end of the second guide member is configured to pass through the at least one slot such that, in the engaged position, the second guide member is configured to move along the slot as the tension adjusting cylindrical tube is moved between the first position and the second position. Further, the length of the slot may define a distance between the first position and the second position.

According to another embodiment of the present invention, a method of manufacturing a telescoping, load-supporting rod assembly configured to engage opposing surfaces is provided. The method may include providing a first portion extending between a first end and a second end, wherein the first portion defines a cavity and an outer diameter, positioning a tension adjustment assembly within the cavity of the first portion of the rod assembly proximate the first end of the first portion and coupling the tension adjustment assembly thereto, coupling a foot member to an end of the tension adjustment assembly, wherein the foot member is configured to engage a corresponding opposing surface when the rod assembly is in an extended position, providing a second portion extending between a first end and a second end, wherein the second portion defines a cavity extending from the first end of the second portion and the cavity has an inner diameter that is larger than the outer diameter defined by the first portion, and inserting at least part of the first portion within the second portion via the first end of the second portion, wherein the tension adjustment assembly is configured to increase the length of the rod assembly while maintaining the relative position of the first and second portions with respect to each other, such that an engagement of the first and second portions with the opposing surfaces is enhanced. In another embodiment, the method may further include placing a tension adjusting cylindrical tube at least partially within the cavity of the first portion, coupling the foot member to an end of the tension adjusting cylindrical tube, placing a tension adjusting spring within the cavity of the first portion and fixing an end of the tension adjusting spring to the first portion, and coupling a movable end of the tension adjusting spring to the tension adjusting cylindrical tube, wherein movement of the tension adjusting cylindrical tube results in movement of the attached foot member, relative to the first portion, between a first position and a second position, wherein the tension adjusting spring is configured to bias the tension adjusting cylindrical tube toward the second position, and wherein in the second position the length of the rod assembly is increased such that an engagement of the first and second portions with the opposing surfaces is enhanced.

According to one embodiment, the method may further comprise defining at least one aperture in the first portion and coupling a first guide member to the fixed end of the spring, wherein positioning the tension adjustment assembly within the cavity of the first portion comprises engaging at least one end of the first guide member with the at least one aperture so as to fix the tension adjustment assembly to the first portion approximately at the fixed end of the spring. According to another embodiment, the method may further comprise defining at least one aperture in the tension adjusting cylindrical tube, wherein positioning the tension adjustment assembly within the cavity of the first portion comprises placing a spring clip at least partially within and coupled to the tension adjusting cylindrical tube such that an extension tab of the spring clip extends through the aperture, wherein the extension tab is configured to pass through a corresponding opening of the first portion when the tension adjustment assembly is disengaged so as to prevent movement of the tension adjusting cylindrical tube toward the second position, and wherein the extension tab is configured to be depressed so as to define an engaged position of the tension adjustment assembly in which the extension tab is received within the first portion so as to allow movement of the tension adjusting cylindrical tube toward the second position as a result of a spring force of the tension adjusting spring.

In one embodiment, the method may include defining at least one slot in the tension adjusting cylindrical tube and coupling a second guide member to the tension adjusting cylindrical tube, wherein at least one end of the second guide member is configured to pass through the at least one slot such that, in the engaged position, the second guide member is configured to move along the slot as the tension adjusting cylindrical tube is moved between the first position and the second position. In another embodiment, the method may include attaching a locking assembly to the second end of the first portion prior to inserting at least part of the first portion within the second portion, wherein the locking assembly is configured to secure the first and second portions with respect to each other. According to one embodiment, the method may also comprise providing a threaded bolt defining a head portion and an elongated portion, wherein the elongated portion comprises a threaded portion; inserting the elongated portion of the threaded bolt into a first longitudinal channel defined by a cylindrical locking portion; and threading the threaded portion of the elongated portion of the threaded bolt into a second longitudinal channel of a cylindrical sleeve such that the cylindrical locking portion is disposed between the head portion of the threaded bolt and the cylindrical sleeve, wherein the second longitudinal channel is aligned with the first longitudinal channel, wherein the cylindrical sleeve is configured to engage the first portion of the rod assembly and the cylindrical locking portion is configured to selectively engage the second portion of the rod assembly, wherein as the head portion of the threaded bolt is advanced toward the cylindrical sleeve as a result of the engagement of the threaded portion with the cylindrical sleeve, contact between the head portion and the cylindrical locking portion and between the cylindrical sleeve and the cylindrical locking portion causes a diameter of the cylindrical locking portion to expand so as to secure the first and second portions with respect to each other.

These characteristics as well as additional features, functions, and details of the present invention are described below. Similarly, corresponding and additional embodiments of rod assemblies and other systems and devices and related methods of the present invention are also described herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a rod assembly according to an example embodiment;

FIG. 2a illustrates a side view of the rod assembly wherein a tension adjustment assembly is disengaged according to an example embodiment;

FIG. 2b illustrates a side view of the rod assembly wherein the tension adjustment assembly is engaged according to an example embodiment;

FIG. 2c illustrates the rod assembly of FIG. 2b from an opposite side;

FIG. 3 illustrates a side view of a first portion of a rod assembly, including a tension adjustment assembly and a twist locking assembly according to an example embodiment;

FIG. 4 illustrates a cross-sectional view of a portion of the first portion and a tension adjustment assembly according to an example embodiment;

FIG. 5a illustrates a cross-sectional side view of the tension adjustment assembly of FIG. 4 according to an example embodiment;

FIG. 5b illustrates a top view of the tension adjustment assembly of FIG. 5a according to an example embodiment; and

FIG. 6 illustrates an exploded side view of a twist locking assembly of a rod assembly according to an example embodiment.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

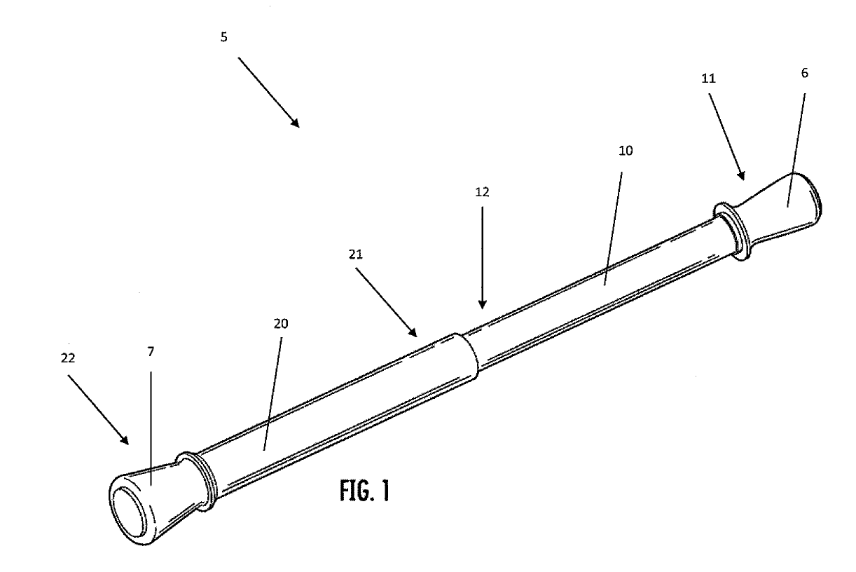

FIG. 1 illustrates a telescoping, load-supporting rod assembly according to an example embodiment of the present invention. Embodiments of the rod assembly 5 are configured to apply pressure at both foot members 6, 7 to opposing walls of a bathtub, shower stall, or other surface (not shown). The foot members 6, 7 may be made of any of a variety of materials, but preferably include a soft or relatively high friction material at the ends of the foot members 6, 7 that are placed in contact with the opposing walls of the bathtub, shower stall, and/or the like so as to hold the rod assembly in position. The rod assembly 5 may include a first portion 10 and a second portion 20. The first portion 10 may extend between a first end 11 and a second end 12. The second portion 20 may extend between a first end 21 and a second end 22, and a cavity may be defined by the second portion 20 that extends from the first end 21 toward the second end 22. An outer diameter of the first portion 10 may be sized such that at least a portion of the first portion may be received within an inner diameter of the cavity of the second portion 20. In this way, the rod assembly 5 may be adjustable along its length to accommodate differently sized bathtubs, shower stalls, and the like.

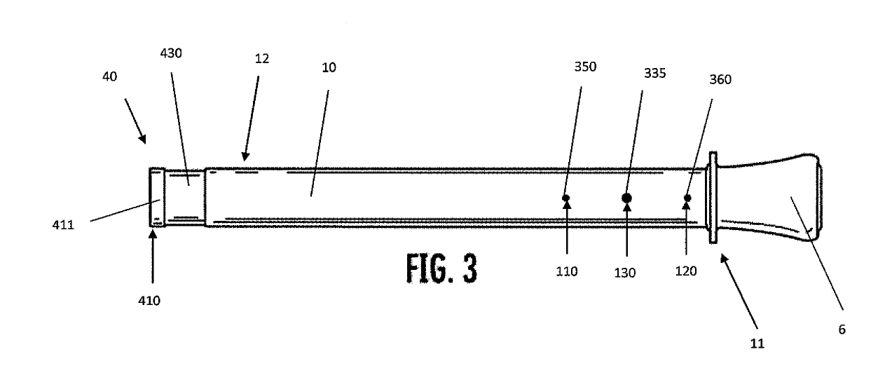

The rod assembly 5 according to an example embodiment may further include a tension adjustment assembly 30 and a twist locking assembly 40, as shown in FIG. 3. The twist locking assembly 40, in an example embodiment, may be coupled to a second end 12 of the first portion 10, while the tension adjustment assembly 30 may be disposed within the first portion 10 near the first end 11 of the first portion 10. The tension adjustment assembly 30 and the twist locking assembly 40, in conjunction with the first portion 10 and the second portion 20, may be configured to allow a user to adjust the length of the rod assembly 5 and secure the rod assembly 5 to opposing walls of a bathtub, shower stall, and/or the like. As such, the length of the rod assembly may be adjusted in two separate ways. In this regard, the twist locking assembly 40 may allow a user to adjust the length of the rod assembly at a macro level (e.g., moving the rod assembly from a collapsed configuration to an expanded configuration), while the tension adjustment assembly 30 may allow the user to make minor adjustments to the length of the rod assembly (e.g., to more fully engage the opposing surfaces between which the rod assembly is installed).

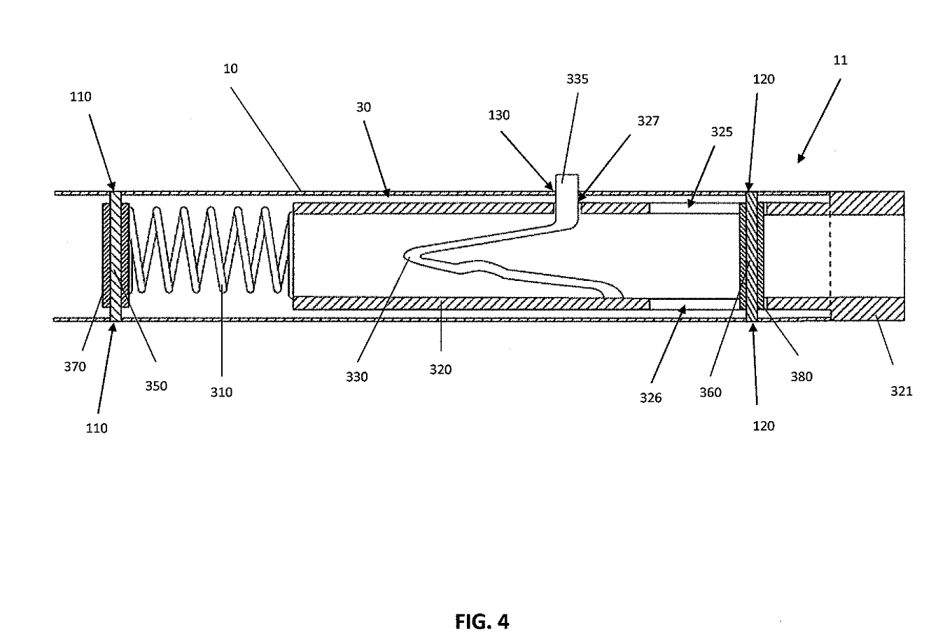

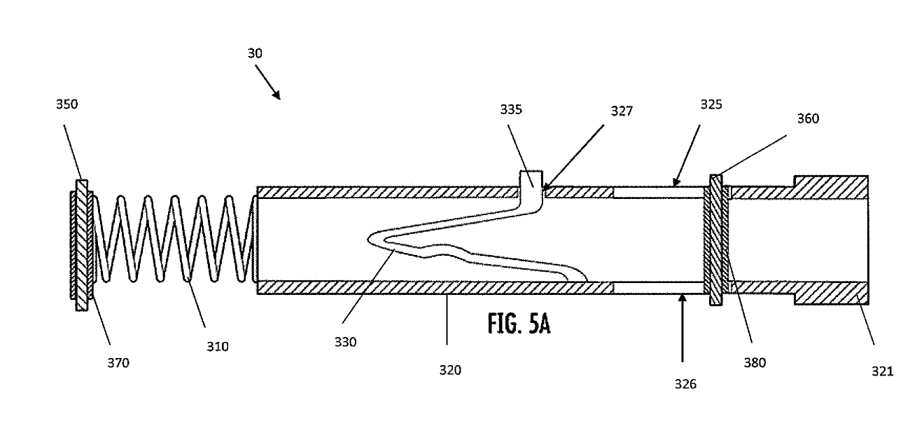

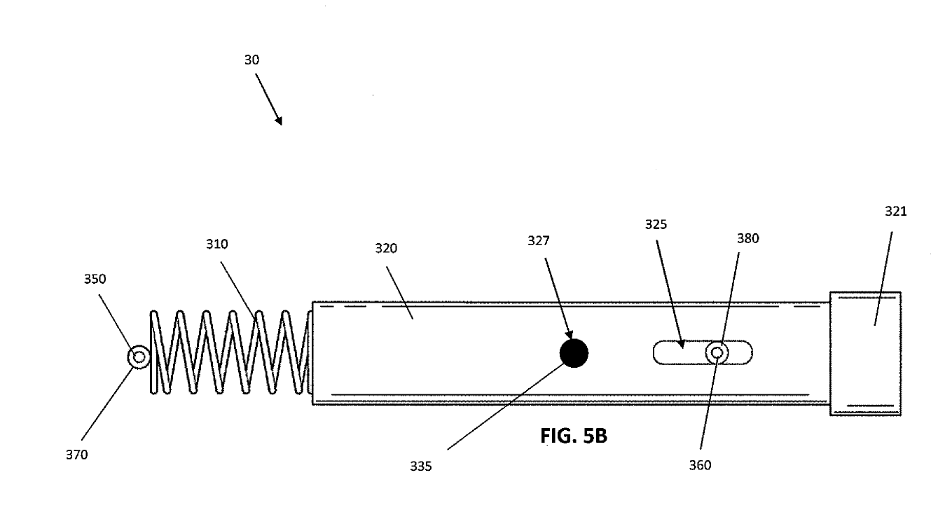

In one example embodiment, the tension adjustment assembly 30 may comprise a spring 310, a tension adjusting cylindrical tube 320, a spring clip 330, and at least two guide members comprising two rivets 350, 360 and at least two spacers 370, 380, as shown in FIGS. 4, 5a, and 5b. According to one embodiment, the tension adjustment assembly 30 may be disposed within and coupled to the first portion 10 of the rod assembly 5, as shown in FIG. 4. The at least two guide members may comprise two spacers 370, 380 that are shaped as cylinders, the cylinders having an inner diameter sized to receive the two rivets 350, 360 therethrough in a friction fit and/or the like. In one example embodiment, the rivets 350, 360 are configured to secure the tension adjustment assembly 30 to the first portion 10 by engaging a plurality of apertures 110, 120 located on the first portion 10 of the rod assembly.

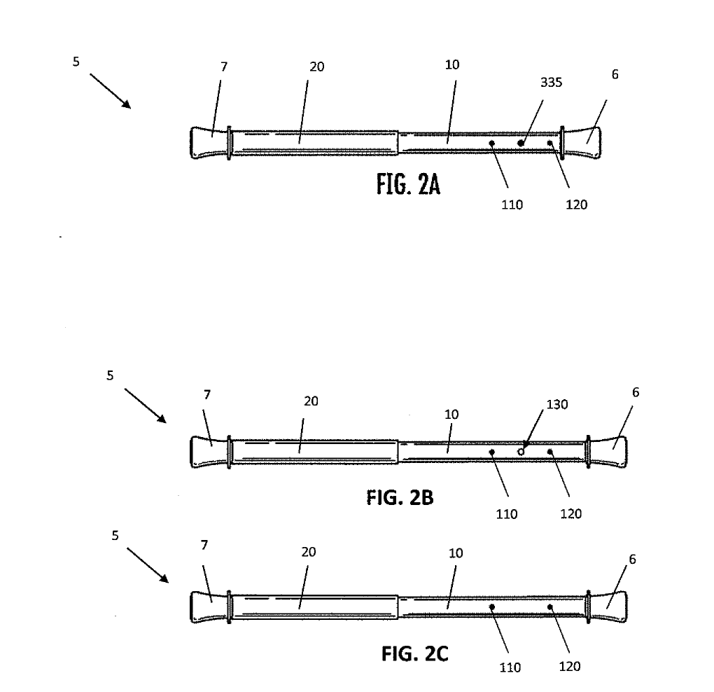

In the example embodiment illustrated in FIGS. 2a-2c, the first portion 10 includes a plurality of openings 110, 120 positioned approximately three and five-eighths inches (3.625″) apart. Further, the pair of openings 110, 120 may be disposed on opposite sides of the cylindrical wall of the first portion 10. For example, FIG. 2b illustrates a first side view of the rod assembly 5, while FIG. 2c illustrates a side view opposite from FIG. 2b. In addition, the openings 110, 120 may be positioned such that the first pair of openings 110 and second pair of openings 120 are positioned along a line parallel to a longitudinal axis of the first portion 10. According to one embodiment, each of the openings 110, 120 may be approximately one-eighth of an inch in diameter and may be configured to receive the rivets 350, 360 therethrough, shown in FIGS. 3 and 4. Although the openings 110, 120 are circular in shape according to the example embodiment, the openings may be square, rectangular, oval, or any of a variety of other geometric and non-uniform desired shapes.

Referring to FIG. 4, a first guide member comprising a spacer 370 may be aligned with the pair of openings 110 of the first portion 10 positioned farthest from the first end 11 of the first portion 10. A first rivet 350 may be configured to be inserted within the pair of openings 110 and the spacer 370, thereby creating a cylindrical bar within the interior space of the first portion 10. The spring 310 of the tension adjustment assembly 30, in an assembled configuration, may be positioned within the first portion 10 so as to substantially abut the spacer 370 and rivet 350. According to one embodiment, a tension adjusting cylindrical tube 320 may be positioned to substantially abut the other end of the spring 310, opposite of the spacer 370 and rivet 350. Further, a spring clip 330 may be disposed within the tension adjusting cylindrical tube 320 such that an extension tab 335 of the spring clip 330 extends through an aperture 327 of the tension adjusting cylindrical tube 320. Further, the tension adjusting cylindrical tube 320 may define two oblong slots 325, 326 thereon, the two oblong slots being disposed approximately 180 degrees from each other. A second spacer 380 may be positioned within the tension adjusting cylindrical tube 320 such that the opening of the spacer 380 is aligned with the oblong slots 325, 326 of the tension adjusting cylindrical tube 320. Once the second spacer 380 and the oblong slots 325, 326 are aligned with the second pair of openings 120 of the first portion 10, the second rivet 360 may be inserted through opening 120 to secure the tension adjustment assembly 30 to the first portion 10, as shown in FIG. 4.

Additionally, the extension tab 335 and the aperture 327 of the tension adjusting cylindrical tube 320 may be aligned with an opening 130 of the first portion 10, such that the extension tab 335 may extend through the opening 130 of the first portion 10 as well as the aperture 327, as shown in FIG. 4. As such, the tension adjustment assembly may be configured to be in a disengaged position when the extension tab 335 extends through the opening 130 of the first portion 10. Specifically, when the extension tab 335 extends through the opening 130 of the first portion, the spring 310 is inhibited from displacing the tension adjusting cylindrical tube 320. Accordingly, when the extension tab 335 is depressed through the opening 130 of the first portion, the spring 310 is thereby allowed to expand and allow for the engagement of the tension adjustment assembly (e.g., moving the tension adjusting cylindrical tube 320 to the right in FIG. 4). Further, the foot member 6 is configured to be engaged by the integrated flange 321 of the tension adjusting cylindrical tube 320 so that a displacement of the tension adjusting cylindrical tube causes a corresponding displacement of the foot member 6.

As previously mentioned, the tension adjusting cylindrical tube 320 may define two oblong slots 325, 326 thereon. The longitudinal axis of the two oblong slots 325, 326 may be disposed parallel to the longitudinal axis of the tension adjusting cylindrical tube 320. The tension adjusting cylindrical tube 320 may further include an aperture 327 defined through the cylindrical wall of the tension adjusting cylindrical tube 320, the aperture 327 disposed along the longitudinal axis of one of the oblong slots 325, 326. The oblong slots 325, 326 may be approximately three-quarters of an inch in length and one-quarter of an inch in width, while the aperture 327, according to one embodiment, may be approximately one-quarter inch in diameter. Although the aperture 327 may be circular in shape according to the example embodiment, the aperture may be square, rectangular, oval, or any of a variety of other geometric or non-uniform desired shapes.

The oblong slots 325, 326 may be shaped such that the length of the oblong slots 325, 326 corresponds to the increase in length of the rod assembly 5 when the tension adjustment assembly 30 is engaged. Specifically, the second guide member comprising the second spacer 380 and second rivet 360 may be positioned within the oblong slots 325, 326 and the openings 120 of the first portion 10 so as to further secure the tension adjustment assembly 30 to the first portion. As such, when the extension tab 335 extends through the opening 130 and the tension adjustment assembly 30 is not engaged, the first portion 10 and the tension adjustment assembly 30 are positioned such that the second spacer 380 and second rivet 360 are at the rightmost position within the oblong slots 325, 326, as shown. When the extension tab 335 is depressed and the spring 310 is allowed to expand, the tension adjusting cylindrical tube 320 extends to right, thereby increasing the length of the rod assembly 5. Accordingly, the first portion 10 and tension adjustment assembly 30 are positioned such that the second spacer 380 and the second rivet 360 are at the leftmost position within the oblong slots 325, 326 when the extension tab 335 does not extend through the opening 130 and the tension adjustment assembly 30 is engaged.

Furthermore, in one example embodiment, the tension adjusting cylindrical tube 320 may include an integrated flange 321 located at the proximal end of the tension adjusting cylindrical tube 320. According to the example embodiment, the integrated flange 321 may be attached to the foot member 6 of the first portion 10 so as to extend and secure the foot member to a wall or surface when the rod assembly 5 when the tension adjustment assembly 30 is engaged by a user. As shown in FIGS. 2a-2c, engagement of the tension adjustment assembly 30 may provide for the extension of the foot member 6 of the first portion 10 from a first position, shown in FIG. 2a, to a second position, shown in FIGS. 2b-2c, thereby increasing the length of the rod assembly 5.

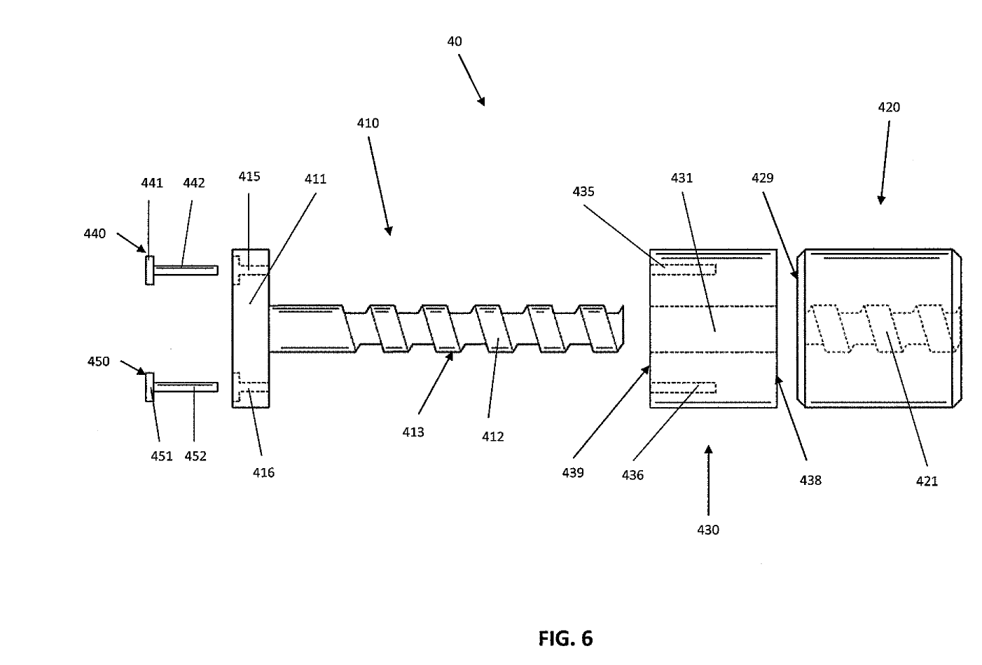

In another example embodiment, the rod assembly 5 further comprises a twist locking assembly 40, as illustrated in FIGS. 3 and 6. The twist locking assembly may further include a threaded bolt 410, a cylindrical sleeve 420, a cylindrical locking portion 430, and a plurality of securing pins 440, 450. Although the threaded bolt 410, cylindrical sleeve 420, and securing pins 440, 450 may be constructed from a plastic in an example embodiment, the threaded bolt, cylindrical sleeve, and securing pins may be constructed from any number of materials, including metals. Further, although the cylindrical locking portion 430 may be constructed from a rubber in an example embodiment, the cylindrical locking portion may be constructed from any number of materials configured to expand or contract when a force is applied to the material and return to an original shape when the force ceases to be applied to the material. As illustrated in FIG. 6, the threaded bolt 410 may comprise a head portion 411 and an elongated portion 413 comprising a threaded portion 412. Further, the head portion 411 may include a plurality of apertures 415, 416. In the example embodiment shown in FIG. 6, the plurality of apertures 415, 416 may be stepped to receive the plurality of securing pins 440, 450 there through. In addition, the threaded portion 412 of the threaded bolt 410 in one embodiment may include a nominal diameter of approximately three-eighths of an inch (⅜″) and approximately twelve threads per inch. In another embodiment, the threaded portion 412 may include a nominal diameter of approximately three-eighths of an inch (⅜″) and approximately nine threads per inch. Further, the threaded bolt 410 may include a head portion 411 having a diameter of approximately seven-eighths of an inch (⅞″) and a length of approximately one-eighth of an inch (⅛″). The threaded portion 412 may be approximately two and seven-eighths of an inch (2⅞″) in length with an outermost diameter of approximately three-eighths of an inch (⅜″). Further, the elongated portion 413 may comprise a portion free of threads that extends approximately one-half of an inch (½″) from the head portion 411.

In addition, the twist locking assembly 40 may include a plurality of securing pins 440, 450. The securing pins may further include a head portion 441, 451 and a rod portion 442, 452 such that the head portion 441, 451 of the securing pins 440, 450 engages the stepped portion of the apertures 415, 416 of the threaded bolt 410. In one embodiment, the securing pins 440, 450 may include a head portion 441, 451 with a diameter of approximately seven-thirty seconds of an inch ( 7/32″) and approximately one-thirty seconds of an inch ( 1/32″) long. Further, the securing pins 440, 450 may include a rod portion 442, 452 of approximately three-sixteenths of an inch ( 3/16″) in diameter and approximately three-quarters of an inch (¾″) long.

The twist locking assembly 40 may also include a cylindrical sleeve 420. In the example embodiment, the cylindrical sleeve 420 includes a longitudinal channel 421 disposed therethrough. The channel may include internal threading configured to engage the external threading of the threaded bolt 410. The cylindrical locking portion 430 may also include a longitudinal channel 431 disposed therethrough. The outer most diameter of the threaded portion 412 of the threaded bolt 410 may be sized to fit within the inner diameter of the longitudinal channel 431 of the cylindrical locking portion 430 (e.g., without engaging the threads 412). The cylindrical locking portion 430 may further include a plurality of cavities 435, 436 configured to receive the plurality of securing pins 440, 450 therein.

In one example embodiment, the twist locking assembly 40 is constructed and attached to the rod assembly in the following manner. The elongated portion 413 of the threaded bolt 410 may be inserted through the longitudinal channel 431 of the cylindrical locking portion 430 such that the plurality of cavities 435, 436 of the cylindrical locking portion are aligned with the plurality of apertures 415, 416 of the head portion 411 of the threaded bolt 410. Further, the elongated portion 413 of the threaded bolt 410 may be inserted through the longitudinal channel 431 of the cylindrical locking portion 430 such that a surface 439 of the cylindrical locking portion 430 substantially abuts the head portion 411 of the threaded bolt 410. Although the cylindrical locking portion 430 and the threaded rod 410 include two cavities 435, 436 and two apertures 415, 416 in the example embodiment, the cylindrical locking portion and threaded bolt may include any equal number of cavities and apertures for securing the cylindrical locking portion to the threaded bolt.

Once the cavities 435, 436 and the apertures 415, 416 are aligned, the securing pins 440, 450 may be inserted through the apertures 415, 416 and into the cavities 435, 436 so as to secure the cylindrical locking portion 430 to the threaded bolt 410. The securing pins may engage the cavities with a friction fit, or in another embodiment, may be attached to the cylindrical locking portion with a weld, adhesive, and/or the like. Once the cylindrical locking portion 430 is attached to the threaded bolt 410, the cylindrical sleeve 420 may be attached to the threaded bolt 410. As noted above, the cylindrical sleeve 420 may include a longitudinal channel disposed therethrough that includes internal threading for engaging the external threads of the threaded bolt 410. As such, a user may thread the cylindrical sleeve 420 onto the threaded portion of the threaded bolt 410 until a surface 429 of the cylindrical sleeve 420 substantially abuts a surface 438 of the cylindrical locking portion 430.

The twist locking assembly 40 may then be inserted into the second end 12 of the first portion 10 such that the cylindrical sleeve 420 engages the inner diameter of the first portion 10. In one embodiment, the cylindrical sleeve 420 may be attached to the first portion 10 by a friction fit. In another embodiment, the cylindrical sleeve 420 may be attached to the first portion 10 with a weld, adhesive, or the like. Once the twist locking assembly 40 and tension adjustment assembly 30 are attached to the first portion 10, as shown in FIG. 3, the assembled first portion 10 may be inserted through the first end 21 of the second portion 20. The cylindrical locking portion 430 of the twist locking assembly 40 may include an outer diameter that engages the inner diameter of the second portion 20. As such, the cylindrical locking portion 430 may be inserted within the second portion 20 with a friction fit such that, initially, the outer diameter of the cylindrical locking portion 430 is at least the size of the inner diameter of the second portion 20 or smaller. The outer diameter of the cylindrical locking portion 430, however, may be sized to at least partially engage the inner diameter of the second portion 20 such that a rotation of the first portion 10 relative to the second portion 20 in a clockwise direction causes the outer diameter of the cylindrical locking portion 430 to engage the inner diameter of the second portion 20. As such, during rotation of the first portion 10 in a clockwise direction relative to the second portion 20, the cylindrical locking portion 430, which is coupled to the threaded bolt 410 with the securing pins 440, 450, may remain stationary with respect to the second portion 20, while the cylindrical sleeve 430, which is coupled to the first portion 10, advances towards the head portion 411 of the threaded bolt 410 along the threads of the threaded portion 412 of the elongated portion 413.

Once the first portion 10 and the second portion 20 are positioned to a desired length, a user may then twist the first portion 10 in a clockwise direction relative to the second portion 20 to engage the twist locking assembly 40. As the first portion 10 is twisted in a clockwise direction, the cylindrical sleeve 420 of the twist locking assembly 40 is threaded further along the threaded portion 412 of the threaded bolt 410 such that the cylindrical sleeve 420 compresses the cylindrical locking portion 430. As the cylindrical locking portion 430 is compressed by the advancement of the cylindrical sleeve 420, the diameter of the cylindrical locking portion 430 increases. In one embodiment, the cylindrical locking portion 430 may have a diameter of approximately 0.94 inches in an uncompressed state. Rotation of the first portion 10 in a clockwise direction relative to the second portion 20 by approximately 90 to 180 degrees may cause the cylindrical sleeve 420 and the head portion 411 of the threaded bolt 410 to compress the cylindrical locking portion 430 such that the diameter of the cylindrical locking portion increases to approximately 1.05 inches. As it is compressed, the cylindrical locking portion 430 exerts an outward force on the inner diameter of the second portion 20 such that the cylindrical locking portion 430 secures the first portion 10 relative to the second portion 20 at the desired length when a user engages the locking assembly. At the same time, rotation of the first portion 10 in a clockwise direction relative to the second portion 20 becomes increasingly difficult as the increasing circumferential surface of the cylindrical locking portion 430 engages the inner diameter of the second portion 20, providing feedback to the user that the first and second portions 10, 20 are secured to each other.

To adjust the rod assembly 5 to a desired length, a user may hold the first portion 10 in his right hand and the second portion 20 in his left hand. While holding the second portion 20, the user twists the first portion 10 in a counterclockwise direction relative to the second portion 20 to disengage the twist locking assembly 40. In one embodiment, the user may twist the first portion 10 counterclockwise approximately between 90 to 180 degrees to disengage and unlock the twist locking assembly 40. Once the twist locking assembly 40 is disengaged, the user may adjust the length of the rod assembly 5 by sliding the first portion 10 within the inner diameter of the second portion 20 to a desired length. Once the user has positioned the first portion 10 and the second portion 20 to the overall desired length, the user may then twist the first portion 10 in a clockwise direction relative to the second portion 20 to engage the twist locking assembly 40 in order to secure the first portion 10 and the second portion 20 in the desired position. In the example embodiment, the user may twist the first portion 10 clockwise approximately 90 to 180 degrees to engage and lock the twist locking assembly 40. With the rod assembly 5 now locked at the desired length, the user may position the foot members 6, 7 onto opposing walls of a shower stall, bathtub, and/or the like. Once the user has positioned the foot members 6, 7 onto the opposing walls at the desired position, the user may engage the tension adjustment assembly 30 to further secure the rod assembly to the opposing walls by depressing the extension tab 335 of the tension adjustment assembly 30 to allow the rod assembly 5 to further expand, as described above. Additional embodiments of the invention described above are provided in the Summary and claims herewith. In addition, the steps described above for embodiments of a method of manufacturing the rod assembly can occur in any order and in any combination, some steps may occur simultaneously.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A telescoping, load-supporting rod assembly configured to be extended to engage opposing surfaces, the rod assembly comprising:
a first portion extending between a first end and a second end, wherein the first portion defines an outer diameter;
a second portion extending between a first end and a second end, wherein the second portion defines a cavity extending from the first end of the second portion and the cavity has an inner diameter that is larger than the outer diameter defined by the first portion, such that the second portion is configured to receive at least a part of the first portion within the cavity via the first end of the second portion; and
a tension adjustment assembly attached to the first portion proximate the first end of the first portion, wherein the tension adjustment assembly is configured to increase the length of the rod assembly while maintaining the relative position of the first and second portions with respect to each other, such that an engagement of the first and second portions with the opposing surfaces is enhanced.

2. A rod assembly accordingly to claim 1 further comprising a locking assembly attached to the second end of the first portion, wherein the locking assembly is configured to secure the first and second portions with respect to each other.

3. A rod assembly according to claim 2, wherein the locking assembly comprises:
a threaded bolt defining a head portion and an elongated portion, wherein the elongated portion comprises a threaded portion;
a cylindrical locking portion defining a first longitudinal channel configured to receive the elongated portion of the threaded bolt; and
a cylindrical sleeve defining a second longitudinal channel that is aligned with the first longitudinal channel, wherein the second longitudinal channel comprises internal threads configured to engage the threaded portion of the elongated portion of the threaded bolt,
wherein the cylindrical locking portion is configured to be disposed between the head portion of the threaded bolt and the cylindrical sleeve,
wherein the cylindrical sleeve is configured to engage the first portion of the rod assembly and the cylindrical locking portion is configured to selectively engage the second portion of the rod assembly, wherein as the head portion of the threaded bolt is advanced toward the cylindrical sleeve as a result of the engagement of the threaded portion with the cylindrical sleeve, contact between the head portion and the cylindrical locking portion and between the cylindrical sleeve and the cylindrical locking portion causes a diameter of the cylindrical locking portion to expand so as to secure the first and second portions with respect to each other.

4. A rod assembly according to claim 3, wherein the head portion of the threaded bolt defines a plurality of apertures configured to receive securing pins therethrough for securing the threaded bolt to the cylindrical locking portion.

5. A rod assembly according to claim 3, wherein, when the threaded portion of the threaded bolt is received within the second longitudinal channel of the cylindrical sleeve, rotation of the first portion in a clockwise direction relative to the second portion advances the head portion of the threaded bolt toward the cylindrical sleeve.

6. A rod assembly according to claim 3, wherein, when the threaded portion of the threaded bolt is received within the second longitudinal channel of the cylindrical sleeve, rotation of the first portion in a counterclockwise direction relative to the second portion causes the cylindrical sleeve to disengage from with the threaded portion such that the head portion of the threaded bolt is moved away from the cylindrical sleeve.

7. A rod assembly according to claim 1 further comprising a foot member coupled proximate the first end of the first portion, wherein the foot member is configured to engage a corresponding opposing surface.

8. A rod assembly according to claim 7, wherein the tension adjustment assembly comprises a tension adjusting cylindrical tube disposed at least partially within a cavity of the first portion and attached to the foot member of the first portion such that movement of the tension adjusting cylindrical tube results in movement of the attached foot member, relative to the first portion, between a first position and a second position, wherein in the second position the length of the rod assembly is increased such that an engagement of the first and second portions with the opposing surfaces is enhanced.

9. A rod assembly according to claim 8, wherein the tension adjustment assembly further comprises a tension adjusting spring disposed within the cavity of the first portion and having a fixed end that is fixed with respect to the first portion and a movable end that is movable with respect to the first portion, wherein the movable end is coupled to the tension adjusting cylindrical tube such that the tension adjusting cylindrical tube is biased toward the second position.

10. A rod assembly according to claim 9, wherein the tension adjustment assembly further comprises a first guide member coupled to the fixed end of the spring and configured to engage at least one aperture defined by the first portion so as to couple the tension adjustment assembly to the first portion at the fixed end of the spring.

11. A rod assembly according to claim 9, wherein the tension adjusting cylindrical tube defines an aperture, wherein the tension adjustment assembly further comprises a spring clip disposed at least partially within and attached to the tension adjusting cylindrical tube, wherein the spring clip includes an extension tab configured to extend through the aperture, wherein the extension tab is configured to pass through a corresponding opening of the first portion when the tension adjustment assembly is disengaged so as to prevent movement of the tension adjusting cylindrical tube toward the second position, and wherein the extension tab is configured to be depressed so as to define an engaged position of the tension adjustment assembly, in which the extension tab is received within the first portion so as to allow movement of the tension adjusting cylindrical tube toward the second position as a result of a spring force of the tension adjusting spring.

12. A rod assembly according to claim 11, wherein the tension adjusting cylindrical tube defines at least one slot and wherein the tension adjustment assembly further comprises a second guide member, wherein at least one end of the second guide member is configured to pass through the at least one slot such that, in the engaged position, the second guide member is configured to move along the slot as the tension adjusting cylindrical tube is moved between the first position and the second position.

13. A rod assembly according to claim 12, wherein a length of the slot defines a distance between the first position and the second position.

14. A method of manufacturing a telescoping, load-supporting rod assembly configured to be extended to engage opposing surfaces comprising:
providing a first portion extending between a first end and a second end, wherein the first portion defines a cavity and an outer diameter;
positioning a tension adjustment assembly within the cavity of the first portion of the rod assembly proximate the first end of the first portion and coupling the tension adjustment assembly thereto;
coupling a foot member to an end of the tension adjustment assembly, wherein the foot member is configured to engage a corresponding opposing surface when the rod assembly is in an extended position;
providing a second portion extending between a first end and a second end, wherein the second portion defines a cavity extending from the first end of the second portion and the cavity has an inner diameter that is larger than the outer diameter defined by the first portion; and
inserting at least part of the first portion within the second portion via the first end of the second portion,
wherein the tension adjustment assembly is configured to increase the length of the rod assembly while maintaining the relative position of the first and second portions with respect to each other, such that an engagement of the first and second portions with the opposing surfaces is enhanced.

15. The method of claim 14, wherein positioning the tension adjustment assembly within the cavity of the first portion comprises:
placing a tension adjusting cylindrical tube at least partially within the cavity of the first portion;
coupling the foot member to an end of the tension adjusting cylindrical tube;
placing a tension adjusting spring within the cavity of the first portion and fixing an end of the tension adjusting spring to the first portion; and
coupling a movable end of the tension adjusting spring to the tension adjusting cylindrical tube,
wherein movement of the tension adjusting cylindrical tube results in movement of the attached foot member, relative to the first portion, between a first position and a second position,
wherein the tension adjusting spring is configured to bias the tension adjusting cylindrical tube toward the second position, and
wherein in the second position the length of the rod assembly is increased such that an engagement of the first and second portions with the opposing surfaces is enhanced.

16. The method of claim 15 further comprising defining at least one aperture in the first portion and coupling a first guide member to the fixed end of the spring, wherein positioning the tension adjustment assembly within the cavity of the first portion comprises engaging at least one end of the first guide member with the at least one aperture so as to fix the tension adjustment assembly to the first portion approximately at the fixed end of the spring.

17. The method of claim 15 further comprising defining at least one aperture in the tension adjusting cylindrical tube, wherein positioning the tension adjustment assembly within the cavity of the first portion comprises placing a spring clip at least partially within and coupled to the tension adjusting cylindrical tube such that an extension tab of the spring clip extends through the aperture,
wherein the extension tab is configured to pass through a corresponding opening of the first portion when the tension adjustment assembly is disengaged so as to prevent movement of the tension adjusting cylindrical tube toward the second position, and wherein the extension tab is configured to be depressed so as to define an engaged position of the tension adjustment assembly in which the extension tab is received within the first portion so as to allow movement of the tension adjusting cylindrical tube toward the second position as a result of a spring force of the tension adjusting spring.

18. The method of claim 17 further comprising defining at least one slot in the tension adjusting cylindrical tube and coupling a second guide member to the tension adjusting cylindrical tube, wherein at least one end of the second guide member is configured to pass through the at least one slot such that, in the engaged position, the second guide member is configured to move along the slot as the tension adjusting cylindrical tube is moved between the first position and the second position.

19. The method of claim 14 further comprising attaching a locking assembly to the second end of the first portion prior to inserting at least part of the first portion within the second portion, wherein the locking assembly is configured to secure the first and second portions with respect to each other.

20. The method of claim 19 further comprising:
providing a threaded bolt defining a head portion and an elongated portion, wherein the elongated portion comprises a threaded portion;
inserting the elongated portion of the threaded bolt into a first longitudinal channel defined by a cylindrical locking portion; and
threading the threaded portion of the elongated portion of the threaded bolt into a second longitudinal channel of a cylindrical sleeve such that the cylindrical locking portion is disposed between the head portion of the threaded bolt and the cylindrical sleeve, wherein the second longitudinal channel is aligned with the first longitudinal channel,
wherein the cylindrical sleeve is configured to engage the first portion of the rod assembly and the cylindrical locking portion is configured to selectively engage the second portion of the rod assembly, wherein as the head portion of the threaded bolt is advanced toward the cylindrical sleeve as a result of the engagement of the threaded portion with the cylindrical sleeve, contact between the head portion and the cylindrical locking portion and between the cylindrical sleeve and the cylindrical locking portion causes a diameter of the cylindrical locking portion to expand so as to secure the first and second portions with respect to each other.
